(19) United States
(12) Patent Application Publication
(10) Pub. No.: US 2021/0288749 A1
(43) Pub. Date: Sep. 16, 2021

(54) ERROR CORRECTION METHOD FOR A UNIDIRECTIONAL DATA TRANSFER

(71) Applicant: Siemens Mobility GmbH, München, Bayern (DE)

(72) Inventors: Tiago Gasiba, München (DE); Matthias Seifert, Buchholz (DE); Martin Wimmer, Neubiberg (DE)

(21) Appl. No.: 17/260,300

(22) PCT Filed: Jul. 9, 2019
(86) PCT No.: PCT/EP2019/068402

§ 371 Date: Jan. 14, 2021

(30) Foreign Application Priority Data
Aug. 3, 2018 (DE) 10 2018 213 065.5

(51) Int. Cl. H04L 1/00; H04L 29/12

(52) U.S. Cl. CPC H04L 1/0041; H04L 61/6063; H04L 1/0009; H04L 1/0047

(57) ABSTRACT

Provided is a method for a unidirectional transfer of data from a transmitter to a receiver, having the steps of: demultiplexing the data into multiple data streams; encoding each of the data streams using a forward error correction coding; transmitting the data streams from the transmitter to the receiver via assigned communication channels; correcting a possible error in one of the received data streams on the basis of the forward error correction coding; removing the forward error correction coding from the data; and multiplexing the data.

### CROSS-REFERENCE TO RELATED APPLICATIONS

This application claims priority to PCT Application No. PCT/EP2019/068402, having a filing date of Jul. 9, 2019, which is based on German Application No. 10 2018 213 065.5, having a filing date of Aug. 3, 2018, the entire contents both of which are hereby incorporated by reference.

### FIELD OF TECHNOLOGY

The following relates to the implementation of unidirectional data traffic. The following also relates in particular to the correct transmission, with increased probability, of data in the case of unidirectional data traffic.

### BACKGROUND

A first data processing system may for example be protected against an external attack by virtue of incoming data connections being blocked. It may sometimes be necessary to transmit data to a second processing system, for example when backup files or log files are intended to be outsourced. While data are being transmitted via a communication channel between the processing systems, errors may however creep into the transmitted data, such that the data may be unusable on the receiver side.

Owing to the unidirectional transmission, the data processing system does not have any knowledge as to whether or not a transfer was successful. The data may be transmitted multiple times in order to increase the probability of successful transmission. This however requires a great deal of bandwidth or a long transmission duration.

A conventional transmission method for data via a communication channel uses return error correction. The data are divided into packets and transmitted individually. Each packet may be provided with a checksum on the basis of which the receiver is able to detect a transmission error. In this case, the receiver reports the packet in question to the transmitter, and the transmitter transmits the packet again. If it is not possible for the receiver to communicate with the transmitter, then it is not possible to use such a transmission method.

### SUMMARY

An aspect relates to an improved technique by way of which data are able to be transmitted correctly, with increased probability, from a transmitter to a receiver via a communication channel even when the communication channel is affected by errors and data transmitted thereby may have a certain probability of being changed.

To this end, it is proposed to use a plurality of unidirectional channels for the transmission and to distribute the data over the channels in a predefined manner.

A first method for the unidirectional data transfer of data from a transmitter to a receiver comprises steps of demultiplexing the data into a plurality of data streams; coding the data streams in each case by way of forward error protection coding; dispatching the data streams via associated communication channels from the transmitter to the receiver; correcting a possible error in one of the received data streams on the basis of the forward error protection coding; removing the forward error protection coding from the data; and multiplexing the data.

According to embodiments of the invention, forward error correction may be combined with transmission via a plurality of communication channels in order to implement correct and suitably efficient transmission of the data with increased probability. In this case, different channels may have different properties and in particular support different transmission speeds. In contrast to the multiple transmission of all of the data, it is possible to save on a significant transmission capacity.

Forward error protection coding of a data stream may contribute a sufficient amount of redundant information not only to identify falsification of the data during the transmission, but also to rectify it. The amount of information interspersed by the forward error protection coding may usually be controlled, wherein the number of correctable errors in the transmitted data may increase with the amount of redundant information. The error correction may normally be performed such that it is also determined whether or not the error rectification was successful. It is in particular possible to determine when there are more errors in the data than are able to be rectified. The method may be able to be scaled well via a number of channels and/or the selection or setting of associated forward error protection coding. The probability of a successful, that is to say unfalsified transmission may be determined on the basis of the redundant information and transmission parameters. By way of example, it is possible to determine that a one-bit error occurs on average every 100 years and a two-bit error occurs on average every 500 years. For certain applications, for instance transmission of logs, this may be accepted as “reliable transmission”.

A plurality of decoders are also accordingly operated in parallel or in series on the receiver side in the reverse order. One particular feature is that these decoders exchange statistical information regarding the error correction with one another and iteratively perform the decoding process, resulting in highly effective error correction for a comparatively low algorithmic expenditure. Although the number of decoders is the same as the number of coders, the number of iterations in the decoding process is generally greater than the number of the decoders.

In one embodiment, at least one of the data streams is coded with forward error protection coding on the basis of a communication channel associated therewith. Communication channels having different probabilities of interference are thus able to be supported in an improved manner. It is possible to avoid adding more redundant information than is suitable for the communication channel.

A second method for the unidirectional data transfer of data from a transmitter to a receiver comprises steps of coding the data by way of forward error protection coding; demultiplexing the data into a plurality of data streams; dispatching the data streams via associated communication channels from the transmitter to the receiver; multiplexing the data at the receiver; correcting a possible error in the received data on the basis of the forward error protection coding; and removing the forward error protection coding from the data.

In contrast to the first method specified above, the coding here takes place prior to the demultiplexing. Occurring errors are able to be corrected in an improved manner in particular when it is able to be assumed that the communication channels have similar probabilities of interference. Features or advantages may be transferred between the methods.

The data streams may for example be dispatched by way of UDP (User Datagram Protocol). To this end, the data may be divided into blocks that are able to be transported by way of UDP. Fragmentation over a plurality of UDP packets may take place. UDP is widespread as unconfirmed transmission protocol, meaning that there may be an increased selection when choosing network components. The transmission may furthermore take place via an existing, possibly even public network. UDP is described in RFC768, and a variant UDP-Lite is described in RFC3828. Any other unidirectional protocol may also be used in practice.

The forward error protection coding may be selected on the basis of a type of data to be transmitted. Text data, which may occur for example in the form of logs, may thus be secured with forward error protection coding different from a video data stream, or binary data of an executable program. Certain patterns such as a distribution of digital characters or a repetition of bit sequences may be given special consideration in this case. The type of data may be determined automatically or be predefined as parameters.

The forward error protection coding may also be selected on the basis of a transmission time and/or transmission duration. If it is known for example that particular times of day involve a lower data throughput and/or a higher probability of bit errors, then the forward error protection coding may contribute more redundant information at these times in order to permit improved compensation of errors.

In one variant of the method, data to be transmitted are contained in a file, wherein the file is divided into a plurality of portions; and the portions are in each case transmitted by way of a method as described in one of the preceding aspects of the description. The portions may in this case be transmitted simultaneously. The file may for example be divided into successive sections, and the sections may be transmitted in a manner interleaved with one another. It is thus possible to form a sliding window, in which data are transmitted, at each section. The windows of the sections may be moved over the data to an equal extent. This may be advantageous in particular in the case of a very large file.

An association between data streams and communication channels may be different for at least two of the portions. This makes it possible to eliminate a systematic error that may arise when parts of the sections are transmitted in a cyclically synchronized manner. It is possible to increase determination reliability of an error and a probability of an error being able to be rectified.

The received data may be stored with the forward error protection coding that they contain, and the forward error protection coding may be removed only in order to access the data. A possible error in the region of a data memory is thereby likewise able to be compensated. In one embodiment, received data may be checked initially for transmission errors. If no errors have occurred, then the received data may be stored in unchanged form. If one or more errors have to be corrected, the redundant information may be recreated following the correction, before the data are stored.

A transmission device for the unidirectional data transfer of data to a receiver comprises a demultiplexer that is designed to demultiplex data; a coder that is designed to code data by way of forward error protection coding; interfaces for connection to a plurality of communication channels; and a processing apparatus. The processing apparatus is in this case designed to control demultiplexing of the data, provision to the data of forward error protection coding and dispatching of the data. This variant may correspond to a first method described herein. A further transmission device may correspond to a second method described herein. In this case, positions of the demultiplexer and of the coder may be swapped with regard to the data flow. Advantages or features of the transmission devices may be exchangeable with one another or between a transmission device and a corresponding method.

The communication channel may be connected to one of the interfaces via a data diode in order to prevent reception of data from one of the communication channels. A plurality of communication channels may in each case be secured by way of an associated data diode. Each data diode may form a dedicated communication channel. A data diode ensures purely unidirectional transmission. An outgoing data diode that prevents reception of data may be provided to protect the transmission device. The data diode may be implemented in the form of a network protocol unit (data capture unit) that may be designed to sample a data transmission between two network components without any feedback. A network protocol unit may be considerably less expensive than a specifically designed data diode. Data communication could be sampled between the coder (or, corresponding to the second method, the demultiplexer) and a blind unit (null device) by way of the network protocol unit and sent via the communication channel. The blind unit may discard the data in their entirety.

A reception device for the unidirectional data transfer of data from a transmitter comprises interfaces for connection to a plurality of communication channels; a multiplexer that is designed to multiplex data; a decoder that is designed to decode data that are provided with forward error protection coding; and a processing apparatus. The processing apparatus is in this case designed to control reception of the data, multiplexing of the data and decoding of the data. This embodiment may correspond to a first method described herein. For an application in connection with a second method described herein, the multiplexer and the decoder may have swapped positions with regard to a data flow. Advantages or features of the reception devices may be able to be exchanged with one another or with the associated transmission devices or corresponding methods.

The communication channel may be connected to the interfaces by way of a data diode in order to prevent dispatching of data by the receiver to another location. An incoming data diode that prevents transmission of data may be provided to protect the reception device.

A system comprises a transmission device described herein, and a reception device described herein. In this case, the interfaces of the transmission device are connected in pairs to those of the reception device.

### BRIEF DESCRIPTION

Some of the embodiments will be described in detail, with reference to the following figures, wherein like designations denote like members, wherein:

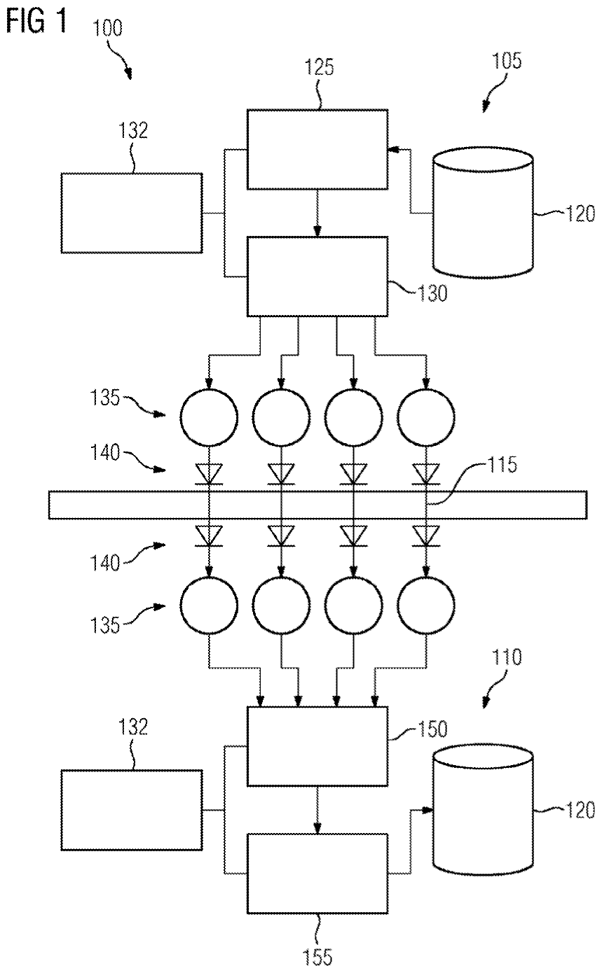

FIG. 1 illustrates an exemplary system;

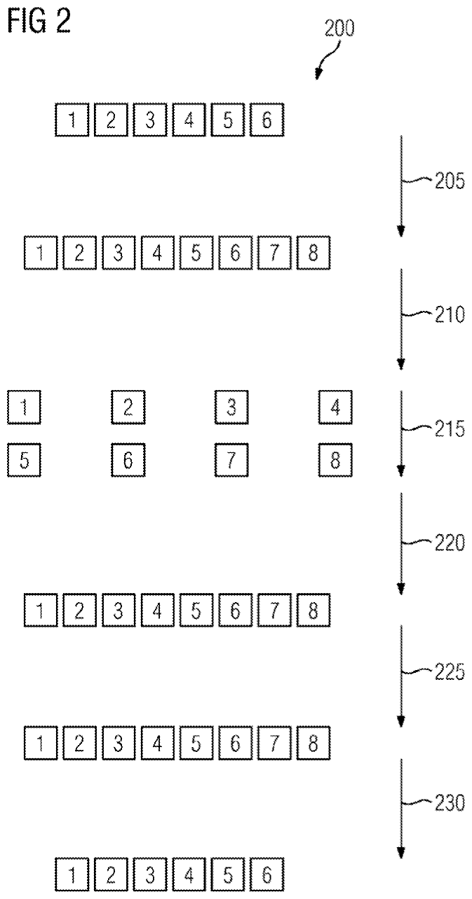

FIG. 2 illustrates an exemplary method; and

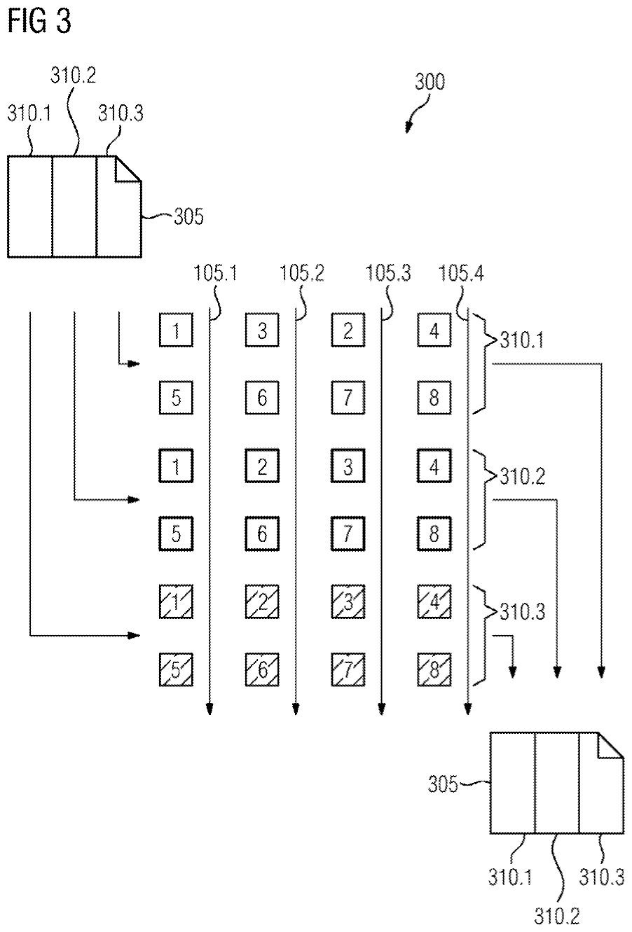

FIG. 3 illustrates a variant of the method.

### DETAILED DESCRIPTION

FIG. 1 shows an exemplary system 100 for the transmission of data between a transmission device 105 and a reception device 110 via a plurality of communication channels 115. It is assumed that the communication channels 115 are of the same type, for example in terms of bandwidth, transmission medium, latency time, error rate or availability. Communication channels 115 that differ to a greater or lesser extent may however also be supported. The transmission device 105 may be part of a larger data processing facility and is designed to send data but not to receive them. The reception device 110 may likewise be part of a larger data processing facility and is conversely designed to receive data but not to send them. A communication should flow only from the transmission device 105 to the reception device 110, and a return channel, even only for confirming a transmitted data block, is not provided.

The transmission device 105 comprises an optional data memory 120, a demultiplexer 125, a coder 130, one or more interfaces 135 and a processing apparatus 132. An outgoing data diode 140 may be provided between an interface 135 and one of the communication channels 115.

The data memory 120 is designed to store a file or structured data that are intended to be transmitted to the reception device 110. The data memory 120 may also be replaced by an interface via which data to be transmitted may be obtained.

The demultiplexer 125 is designed to divide the data to be transmitted into a plurality of data streams, wherein a data stream is associated with each communication channel and vice versa. For the division, data present in sequential form may be broken down into packets and these may be allotted to different data streams, for example cyclically. The division may be performed in a known manner such that transmitted packets are subsequently able to be recombined to form the original data, for example by virtue of the packets carrying sequence numbers.

The coder 130 is designed to code data that it receives from the demultiplexer 125 using forward error protection coding. In this case, it systematically adds redundant information to the data. Checksums are possibly also formed from one or more packets and inserted in order to make it possible to determine an error in the data. A coder 130 may be provided for each data stream 115, or the coder 130 may operate independently on a plurality of data streams 115. Combined operation, in which it codes a plurality of data streams 115 in a manner dependent on one another, is also possible. The coder 130 provides data packets that are able to be transported by way of UDP.

The interface 135 is designed to output outgoing data to a transmission medium of an associated communication channel 115. In this case, information may in particular be converted into a physical phenomenon such as a light value or current value. In one embodiment, a single interface 135 is provided for a plurality of data streams and communication channels 115.

The data diode 140 is designed to convey data only in a predetermined direction that is depicted by the arrow direction in FIG. 1. The symbol for a diode, borrowed from electrical engineering, shows that a flow of information counter to the arrow direction is blocked. Such communication is also called simplex communication. A dedicated commercial solution may be used to implement a data diode 140. As an alternative, it is possible to use a network protocol unit that is able to provide data to the communication channel in a unidirectional manner and without any feedback. Such an apparatus is also known as a “data capture unit”. In an embodiment different from the one shown, the positions of the data diode 140 and of the interface 135 are swapped.

The processing apparatus 132 comprises a programmable microcomputer or microcontroller and is designed to control components of the transmission device 105. In this case, the processing apparatus 132 may also comprise one or more of the other elements of the transmission device 105.

In the present embodiment, at the transmission device 105, data to be transmitted are first demultiplexed and then coded. In another embodiment, first coding and then demultiplexing may also take place. To this end, the positions of the elements 125 and 130 in the transmission device 105 may be swapped; only one connection, instead of a plurality as illustrated, between them is then necessary.

The reception device 110 operates in a manner complementary to the transmission device 105. It comprises essentially the same elements as the transmission device 105, and only a demultiplexer 145 instead of the multiplexer 125 and a decoder 150 instead of the coder 130 are provided. All of the variations described above with regard to the transmission device 105 are also possible here. Variants of the transmission device and the reception device 105, 110 may be selected independently of one another, but the orders of demultiplexing and coding at the transmission device 105 and decoding and multiplexing at the reception device 110 must be matched to one another.

The demultiplexing and decoding take place in the reverse order with respect to the transmission device 105. In the embodiment illustrated, the data streams received via the interfaces 135 are thus first decoded on the receiver side in each case by way of the decoder 150 and then multiplexed by way of the multiplexer 145. In another embodiment, in which first coding and then demultiplexing take place on the transmitter side, first multiplexing and then decoding are performed on the receiver side. In any case, the result is that the transmitted data are present again in the original format and are able to be stored in the data memory 120. This data memory 120 may also be replaced by an interface via which the data are provided.

The demultiplexing comprises combining fragments to form a file or a data stream. The decoding comprises removing redundant information that was added at the transmission device 105. In this case, it is first of all checked, on the basis of checksums from certain sections of data, whether a defect occurred in the data during the transmission. For one section, it is usually possible to determine errors up to a first predetermined number of defective bits. Errors up to a second predetermined number of bits may also be repaired, wherein the second number is usually smaller than the first.

In a further embodiment, the decoding may also be suspended until the received data have been used. To this end, the demultiplexed but not yet decoded data may initially be stored in the data memory 120. If it is intended to access the data, the required decoding may be performed immediately.

FIG. 2 shows a schematic flowchart of a method 200 for transmitting data, in particular by way of a system 100 as is illustrated in FIG. 1. The data are first of all present in an exemplary block that comprises six units. A unit may correspond for example to a UDP packet or its payload.

In a first step 205, the data are coded using forward error protection coding, wherein information is added, giving rise to eight units of data. The additional information may be added at any points; there is usually a certain amount of interleaving in which the new information is distributed reasonably equally over the net data to be secured. The amount of information that is added may usually be controlled, wherein more added information may generally lead to a more robust transmission.

The forward error protection coding may comprise a block code, a continuous code or a turbo code. A block code always operates on a data block of a predetermined length; known block codes comprise Reed-Solomon, Reed-Miller, Golay, multidimensional parity, MDS, Hadamard, Expander or Hamming. A continuous code, also called convolutional code, permits the transmission of a potentially infinite data stream. However, no systematic method for generating an appropriate convolutional code is known for a given situation. It is attempted to model eigen types of the data to be transmitted or of the transmission medium through the appropriate selection of particular parameters of the convolutional code. It is often necessary to check a large number of possible convolutional codes in a simulation in terms of its applicability. A convolutional code is usually decoded by way of a Viterbi algorithm.

A turbo coder consists of at least two parallel-connected or series-connected coders for the elementary coding. The elementary coders in each case on their own constitute a particular channel code. The first coder receives the payload data in unchanged form, and the output thereof is forwarded, via what is known as an interleaver that implements the data order in accordance with defined rules, to the second coder as input. The second coder, in the case of only two coders, finally delivers the data sequence to be transmitted.

In a step 210, the coded data are multiplexed. In this case, a respective sequence of data units is associated with a plurality of communication channels 115. The multiplexing may take into consideration the fact that different communication channels 115 may have different data throughputs. A communication channel 115 with a high data throughput may receive more data units per time than a communication channel 115 with a lower data throughput. In a step 215, the data are then transmitted from the transmission device 105 to the reception device 110.

In a step 220, the data are multiplexed such that the individual units are again in the same order as prior to step 210. The result may optionally be stored in a step 225. At another time, for example when it is intended to access the stored data, in a step 230, decoding may take place in which the redundant information that was added in step 205 is removed again. The data may then be transmitted or stored again.

FIG. 3 shows a variant 300 of the method 200 from FIG. 2. In order to transmit a file 305, this should not be processed sequentially, but rather broken down into a plurality of parts 310 in order then to transmit the parts 310 in each case via the communication channels 115 in a manner already described herein. What is decisive in this case is that the parts 310 are transmitted via the communication channels 115 concurrently, simultaneously or in interleaved form. It is furthermore desirable for a distribution of data units on communication channels 115 (see FIG. 2) to be different for at least two of the generated data streams in order to increase the entropy on the transmission path.

In the present example, four parts 310 and four communication channels 115 are provided. In the context of the illustration, eight data units are intended to be transmitted by each part 310. To this end, the units 1 and 5 are transmitted by a first part 310.1, the units 1 and 5 are transmitted by a second part 310.2 and the units 1 and 5 are transmitted by a third part 310.3 via a first communication channel 115.1. The units transmitted via the other communication channels 115, of the parts 310 may be read off from FIG. 3.

The described procedure ensures that units are transmitted by all parts 310. A window of data of each part 310 that is located in the transmission is moved continuously in this case. Reference is also made to a “sliding window” approach.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for the unidirectional data transfer of data from a transmitter to a receiver, wherein the method comprises the following steps:
demultiplexing the data into a plurality of data streams;
coding the data streams in each case by way of forward error protection coding;
dispatching data streams via associated communication channels from the transmitter to the receiver;
correcting a possible error in one of the received data streams on the basis of the forward error protection coding;
removing the forward error protection coding from the data; and
multiplexing data.

2. The method as claimed in claim 1, wherein at least one of the data streams is coded with forward error protection coding on the basis of a communication channel associated therewith.

3. A method for the unidirectional data transfer of data from a transmitter to a receiver, wherein the method comprises the following steps:
coding the data by way of forward error protection coding;
demultiplexing the data into a plurality of data streams;
dispatching the data streams via associated communication channels from the transmitter to the receiver;
multiplexing the data at the receiver;
correcting a possible error in the received data on the basis of the forward error protection coding; and
removing the forward error protection coding from the data.

4. The method as claimed in claim 1, wherein the data streams are dispatched by way of UDP.

5. The method claimed as claimed in claim 1, wherein the forward error protection coding is selected on the basis of a type of data to be transmitted.

6. The method as claimed in claim 1, wherein the forward error protection coding is selected on the basis of a transmission time and/or transmission duration.

7. A method, wherein data to be transmitted are contained in a file; the file is divided into a plurality of portions; and the portions are in each case transmitted by way of a method as claimed in claim 1.

8. The method as claimed in claim 7, wherein the portions are transmitted simultaneously.

9. The method as claimed in claim 7, wherein an association between data streams and communication channels is different for at least two of the portions.

10. The method as claimed in claim 1, wherein the received data are stored with the forward error protection coding that they contain and the forward error protection coding is removed only in order to access the data.

11. A transmission device for the unidirectional data transfer of data to a receiver, wherein the transmission device comprises the following:
a demultiplexer that is designed to demultiplex data;
a coder that is designed to code data by way of forward error protection coding;
interfaces for connection to a plurality of communication channels; and
a processing apparatus that is designed to control demultiplexing of the data, provision to the data of forward error protection coding and dispatching of the data.

12. The transmission device as claimed in claim 11, wherein the communication channel is connected to one of the interfaces by way of a data diode in order to prevent reception of data from one of the communication channels.

13. A reception device for the unidirectional data transfer of data from a transmitter, wherein the reception device comprises the following:
interfaces for connection to a plurality of communication channels;
a multiplexer that is designed to multiplex data;
a decoder that is designed to decode data that are provided with forward error protection coding;
a processing apparatus that is designed to control reception of the data, multiplexing of the data and decoding of the data.

14. The reception device as claimed in claim 13, wherein the communication channel is connected to the interfaces by way of a data diode in order to prevent dispatching of data via one of the communication channels.

15. A system comprising a transmission device as claimed in claim 11 and a reception device.
